(19) United States
(12) Patent Application Publication
(10) Pub. No.: US 2025/0276584 A1
(43) Pub. Date: Sep. 4, 2025

(54) METHOD FOR OPERATING A MOTOR VEHICLE, COMPUTER PROGRAM PRODUCT, STORAGE MEDIUM, COMPUTER DEVICE

(71) Applicant: Robert Bosch GmbH, Stuttgart (DE)

(72) Inventors: Markus Beisswenger, Schwaebisch Hall (DE); Jan Becker, Backnang (DE); Paul Oborowski, Abstatt (DE)

(21) Appl. No.: 19/065,092

(22) Filed: Feb. 27, 2025

(30) Foreign Application Priority Data
Feb. 29, 2024 (DE) 10 2024 201 863.5

(51) Int. Cl. B60L 15/20; B60K 1/02

(52) U.S. Cl. CPC B60L 15/2009; B60K 1/02; B60L 2240/461; B60L 2240/463; B60L 2240/465

(57) ABSTRACT

A method for operating a motor vehicle. The motor vehicle has at least one axle with a first and a second wheel, wherein the first wheel, assigned to a left-hand side of the motor vehicle, is assigned a first wheel brake device with a controllable first actuator, the second wheel, assigned to a right-hand side of the motor vehicle, is assigned a second wheel brake device with a controllable second actuator. As a function of a braking request for a maximum deceleration of the motor vehicle, at least one torque target value and one rotational speed limit value are specified, and, for fulfilling the braking request, the actuators are controlled as a function of the specified torque target value and the specified rotational speed limit value.

### FIELD

The present invention relates to a method for operating a motor vehicle, wherein the motor vehicle has at least one axle with a first and a second wheel, wherein the first wheel, in particular assigned to a left-hand side of the motor vehicle, is assigned a first wheel brake device with a controllable first actuator, in particular an electric machine, wherein the second wheel, in particular assigned to a right-hand side of the motor vehicle, is assigned a second wheel brake device with a controllable second actuator, in particular an electric machine, and wherein the wheels are assigned a common drive device, or each of the wheels is assigned a separate drive device, with an or each with a controllable third actuator, in particular an electric machine.

Furthermore, the present invention relates to a computer program product which performs the above method if the computer program product is executed on a computer device. The present invention also relates to a machine-readable storage medium having such a computer program product and to a computer device specifically configured to execute the computer program product or to perform the aforementioned method.

### BACKGROUND INFORMATION

It is conventional in the related art to use the existing electric drive device(s) in electrically driven motor vehicles together with or instead of the wheel brake devices in order to decelerate the motor vehicle. The drive device is usually involved, in particular at a low friction coefficient, up to full deceleration or maximum deceleration, i.e. a maximum possible deceleration, which fully utilizes the physical limits, which are mainly determined by the corresponding surface.

### SUMMARY

In a method according to an example embodiment of the present invention, at least one torque target value and one rotational speed limit value are specified as a function of a braking request for a maximum deceleration of the motor vehicle, and for fulfilling the braking request, the actuators are controlled as a function of the specified torque target value and the specified rotational speed limit value. As mentioned above, in addition to the corresponding wheel brake devices (friction brakes) with the electric drive device (drivetrain), one or more further independent actuators for realizing a deceleration task generated by a corresponding braking request are used according to the present invention in order to fulfill the braking request. The electric drive has advantages over a classic friction brake actuator in some respects; in particular, an electric drive can actuate torque changes in both directions symmetrically and continuously. Furthermore, the control task in the electric drive is advantageously solved more dynamically due to very fast cycle times (typically 2 ms in comparison to 5 ms for the friction brake). While the electric drive can be used as the sole actuator for setting the deceleration in some driving situations with low friction coefficients, this does not apply to the majority of driving situations. In particular at high driving speeds or at higher friction coefficients, a large portion of the deceleration power must be provided via the friction brake since the electric drivetrain is typically significantly limited in its regenerative power. The problem of limited regenerative power can be avoided by controlling the electric drive as consistently as possible within its potentials, while the friction brake takes over not only the power difference but also the high-frequency torque modulation. This only allows the low-dynamic incorporation of the electric drivetrain into the deceleration task, at least in a working range in which the power of the electric drivetrain no longer suffices for accomplishing the deceleration task alone. For this reason, during deceleration, electrical torque must be transferred to the friction brake torque (blending) when the regenerative torque approaches the torque limit of the electric drive. In order to bring the friction brake to an operating point at which the modulation via the friction brake is possible, a disproportionately high regenerative torque must be blended. The limited use of regenerative braking in the case of maximum deceleration at low friction coefficients can lead to reduced steerability and a slightly increased braking distance. Furthermore, noticeable longitudinal acceleration disturbances can occur during blending. It is fundamentally possible to control the actuators of the wheel brake devices in such a way that the friction brakes take over the power difference, while the modulation task (i.e., the rotational speed task or slip control task) remains with the actuator of the electric drive regardless of the friction coefficient. In this respect, the friction brake is consistently limited to low-frequency torque components, while the high-frequency components are actuated by the electric drivetrain. This means that the electric drive can be used for the wheel slip control task across the entire operating range. However, this solution is problematic, in particular in the case of electric axle drives, in that wheel-specific control is structurally not possible, since the control acts on both wheels of the axle via the axle drive and a generally open differential gear. As a result, high wheel brake slip can occur on one side, in particular in the case of inhomogeneous road surfaces or inhomogeneous normal force distributions. This slip can only be inadequately compensated by the axle modulation and can result in a longer braking distance. The present invention solves this problem by providing an advantageous structure in which not only the drive device, in particular as an electric axle drive, but also the wheel brake devices designed as friction brakes are or can be simultaneously involved in the control task, whereby a high-frequency actuation at the wheel level is achieved. This advantageously achieves optimal deceleration, even on non-ideal surfaces and in the case of uneven normal force distribution. According to the present invention, the, in particular central, specification of torque target values and rotational speed limit values is provided, in particular for each wheel and/or axle in each case, which values form the basis for the control of all actuators, i.e. not only the wheel brake devices but also the drive device. As already described above, the drive device is designed in particular as an axle drive by means of an open differential. According to the present invention, a central function for specifying the torque target values and rotational speed limit values is provided and has a superordinate influence on the control of the actuators in order to ensure optimal deceleration. The actual control task is performed on the wheel level itself, wherein a coordination task only arises for the wheel(s) to which torque can be applied by more than one actuator, which are therefore assigned according to the present invention not only to the or one of the drive devices but also to one of the wheel brake devices. However, the control structure according to the present invention can also be used to incorporate wheels having only a single actuator

According to a preferred development of the present invention, it is provided that the or a corresponding rotational speed limit value and/or torque target value is specified for each wheel and/or the axle as a function of an optimal slip value. This advantageously ensures that a maximum possible deceleration power is always achieved. A corresponding individual rotational speed limit value and/or torque target value is thus specified not only for each wheel but also for the axle.

According to an example embodiment of the present invention, preferably, it is provided that a common or a corresponding torque target value is/are specified for the first and/or the second actuator as a function of a torque target value for the third actuator and an actual torque generated by the third actuator. This creates a particularly advantageous dependency of the target value(s) for the wheel brake devices on the target value for the drive device so that overall coordinated control of the actuators is ensured.

According to an example embodiment of the present invention, it is particularly preferably provided that the torque target value and the rotational speed limit value are specified by a central control device, and/or that each of the actuators is assigned its own control unit, in particular one that is connected to the central control device by communication technology, wherein each of the actuators is controlled by the control unit assigned to it. The specification by a central control device is advantageous in that the torque target value and rotational speed limit value, as already described above, are specified upstream and are valid for all actuators. If an independent control unit is used for each of the actuators this is advantageous in that the actuators can always be safely controlled independently of one another. The combination of a central control device and independent control units is particularly advantageous so that the central control device specifies the torque target value and the rotational speed limit value and passes them to the control units via a connection by communication technology so that the actual control task lies with the control units. In particular, a rotational speed control is provided.

According to a preferred development of the present invention, it is provided that a first rotational speed limit value of a rotational wheel speed of the first wheel for the first actuator and a second rotational speed limit value of a rotational wheel speed of the second wheel for the second actuator are ascertained and/or specified. The corresponding rotational speed limit values for the actuators of the corresponding wheel brake devices therefore relate to the rotational speed of the corresponding wheel and, in particular, as already described above, are specified for the corresponding wheel as a function of an optimal slip value. This advantageously ensures that the actuators are always optimally controlled for fulfilling the braking request. The optimal rotational speed limit values of the wheels are ascertained, for example calculated by means of a corresponding central control device, in particular in such a way that a maximum longitudinal force is achieved on the wheels while observing the rotational speed limit values.

According to an example embodiment of the present invention, it is particularly preferably provided that a third rotational speed limit value of a rotational axle speed of the axle for the third actuator is specified as a function of the first and second rotational speed limit values, in particular as an average value of the first and the second rotational speed limit values. Specifying the corresponding rotational speed limit value for the rotational axle speed is advantageous in that the actuator of the drive device is also optimally incorporated into the control task. Preferably, the corresponding rotational speed limit value for the axle is ascertained, for example calculated by means of a corresponding central control device, as the average value of the optimal rotational speed limit values from the aforementioned optimal rotational speed limit values for the wheels, taking into account the differential coupling of the electric drive, according to which the rotational axle speed corresponds to the average value of the rotational wheel speeds. Assuming an open differential, this specification as the average of the other two rotational speed limit values represents a particularly advantageously simple and robust solution. The limit value calculated in this way for the rotational axle speed is preferably sent unchanged to a corresponding control unit of the drive device.

According to a preferred development of the present invention, it is provided that, for the first and the second ascertained rotational speed limit values, a correction value, in particular as an offset, is ascertained in each case as a function of a specified slip value at the corresponding wheel, in particular as a function of a deviation from the specified slip value, and that the rotational speed limit values are specified for the corresponding actuators as rotational speed limit values reduced by the corresponding correction values. By correcting the rotational speed limit values in this way, the existing kinematic coupling of the corresponding wheels to the drive device is taken into account because one of the existing degrees of freedom of movement is already utilized by the aforementioned specification of the rotational speed limit value for the rotational axle speed. The correction value is preferably variable and is ascertained, for example, as a function of a desired deviation from the slip value (slip deviation). Since only two degrees of freedom exist due to the kinematic coupling of the two wheels to the drive, it is advantageous to take this into account in the specification of the rotational speed limits in the friction brakes because one degree of freedom is already utilized, as described, by the specification of the rotational axle speed. In deviation from the aforementioned optimal (deceleration) rotational speed limit values for the wheels, the specifications for the rotational wheel speed limits are therefore preferably reduced by a corresponding delta, namely the (positive) correction value. The corrected rotational speed limit values then ascertained are preferably sent to corresponding control units of the wheel brake devices. The combination of the aforementioned features, i.e. the dependent and offset-based ascertainment of the wheel-specific and axle-specific rotational speed limit values, structurally ensures that the three actuators involved and their control units work together cooperatively as rotational speed controllers. One degree of freedom is always served by the electric drive device, i.e., the rotational axle speed is initially always to be kept at the corresponding rotational speed limit value. Due to the kinematic coupling, it is impossible under this assumption for both rotational wheel speeds to fall below their respective rotational speed limit values at the same time. Rather, on inhomogeneous surfaces or in the case of unequal normal forces, exactly one wheel will fall to or below the corresponding rotational speed limit value and will then be brought back by retracting the actuation of the corresponding wheel brake device. Due to the kinematic coupling, the other wheel must be above its rotational speed limit value, which means that the corresponding rotational speed monitoring is passive.

According to an example embodiment of the present invention, it is particularly preferably provided that an actual value of a rotational wheel speed of the first wheel, an actual value of a rotational wheel speed of the second wheel, and/or an actual value of a rotational axle speed of the axle are detected, that each actual value is compared with its corresponding rotational speed limit value, and that, if it is detected that the particular actual value falls below the rotational speed limit value, the corresponding actuator, in particular the first or the second actuator, will be controlled to reduce the torque, until the actual value at least reaches the rotational speed limit value again. This results in a particularly advantageous, wheel-specific control, in which advantageous rotational speed monitoring is realized in each case by detecting the actual values of the rotational speeds. The procedure described, i.e. controlling the corresponding actuator when the corresponding rotational speed limit value is undershot, ensures that the corresponding rotational speed monitoring automatically will deviate from the torque specification, i.e. the corresponding target torque, if the measured rotational speed is below the specified rotational speed limit. As a result, the control is carried out particularly robustly and reliably.

The computer program product according to an example embodiment of the present invention for execution on a computer device with executes the method according to the present invention when used as intended. This results in the advantages already mentioned.

The machine-readable storage medium according to the present invention includes the computer program product according to the present invention stored thereon.

A computer device according to an example embodiment of the present invention is specifically configured to execute the computer program product according to the present invention or to perform the method according to the present invention. This also results in the advantages already mentioned above. Preferably, the computer device is a control device and/or control unit assigned to a motor vehicle, in particular arranged in the motor vehicle.

For example, a corresponding motor vehicle comprises at least one axle with a first and a second wheel, wherein the first wheel, in particular assigned to a left-hand side of the motor vehicle, is assigned a first wheel brake device with a controllable first actuator, in particular an electric machine, wherein the second wheel, in particular assigned to a right-hand side of the motor vehicle, is assigned a second wheel brake device with a controllable second actuator, in particular an electric machine, and wherein the wheels are assigned a common drive device, or each of the wheels is assigned a separate drive device, with an or each with a controllable third actuator, in particular an electric machine, and is characterized by at least one computer device according to the present invention designed as a central control device and/or a computer device according to the present invention designed as a control unit assigned to at least one of the actuators. This results in the advantages mentioned above.

Further preferred features and combinations of features result from what was described above and the rest of the disclosure herein. The present invention is explained in more detail below with reference to the figures.

### BRIEF DESCRIPTION OF THE DRAWINGS

FIG. 1 shows components of an advantageous motor vehicle, according to an example embodiment of the present invention.

FIG. 2 shows a method for operating the motor vehicle, according to an example embodiment of the present invention.

FIG. 3 shows progression diagrams during the method according to an example embodiment of the present invention.

### DETAILED DESCRIPTION OF EXAMPLE EMBODIMENTS

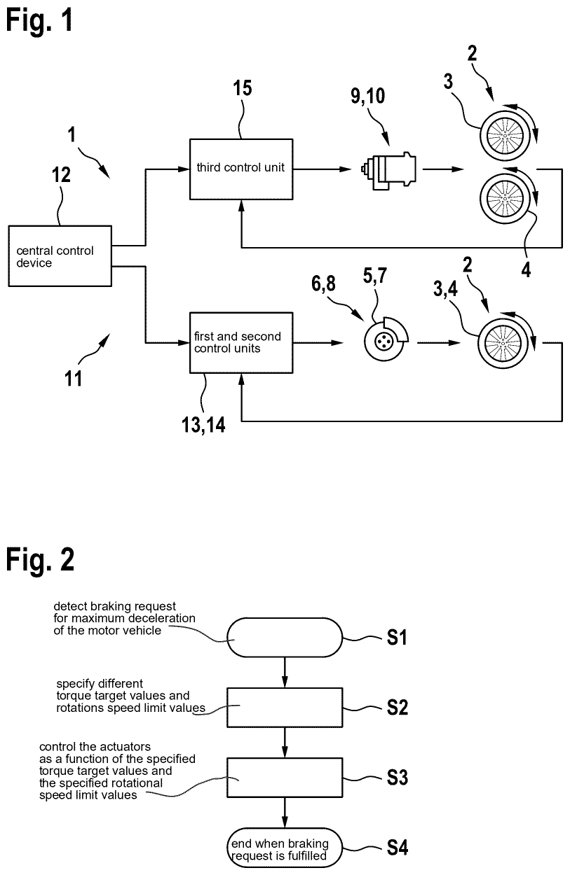

FIG. 1 shows, only schematically, components of an advantageous motor vehicle 1 and their connections to one another. The motor vehicle 1 has at least one, preferably two, axles 2, which are not directly visible in the representation. The axle 2 has a first wheel 3 assigned to a left-hand side of the motor vehicle 1 and a second wheel 4 assigned to a right-hand side of the motor vehicle 1.

The first wheel 3 is assigned a first wheel brake device 5 with a controllable first actuator 6. The second wheel 4 is assigned a second wheel brake device 7 with a controllable second actuator 8. The wheel brake devices 5, 7 and the actuators 6, 8 here are identical. FIG. 1 therefore shows, by way of example, only one of the wheel brake devices 5, 7 with the corresponding actuator 6, 8. The actuators 6, 8 are preferably designed as electric machines in each case. Alternatively, the actuators 6, 8 are hydraulic actuators, in particular as part of a standard hydraulic friction braking system.

In the present case, the wheels 3, 4 are also assigned a common drive device 9, which acts on the wheels 3, 4 in particular via an open differential via the axle 2. For this purpose, the drive device 9 has a controllable third actuator 10 designed as an electric machine.

For controlling the actuators 6, 8, 10, a control arrangement 11 is also provided. The control arrangement 11 has a central control device 12 and multiple control units 13, 14, 15, which are connected thereto by communication technology and which are each assigned to exactly one of the actuators 6, 8, 10 and are designed to control the corresponding actuator 6, 8, 10. A first control unit 13 is assigned to the first actuator 6, a second control unit 14 is assigned to the second actuator 8, and a third control unit 15 is assigned to the third actuator 10.

The central control device 12 is designed to specify certain values to the control units 13, 14, 15 that are in particular subordinate thereto, as a function of which values the control units 13, 14, 15 then control the corresponding actuators 6, 8, 10. In the present case, the central control device 12 is designed to specify torque target values and rotational speed limit values. The control units 13, 14, 15 are designed to carry out a rotational speed control as a function of a current rotational wheel speed or axle speed by correspondingly controlling the actuators 6, 8, 10. This is indicated by corresponding arrows.

An advantageous method for operating the motor vehicle 1 is described below with reference to FIG. 2. For this purpose, FIG. 2 shows the method with the aid of a flow chart. In particular, the method ensures that, when a braking request is fulfilled, an optimal deceleration and distribution of the deceleration power to the involved actuators of the motor vehicle 1 is always achieved. The method is performed, as already indicated above, by means of the control arrangement 11.

In a step S1, the method begins by detecting a braking request for a maximum deceleration of the motor vehicle 1. The term “maximum deceleration” is understood here to mean that the motor vehicle 1 is to be braked with the maximum possible deceleration, in particular to a standstill. For this purpose, the corresponding actuators 6, 8, 10 are to be controlled in a coordinated manner.

In a step S2, different torque target values and rotational speed limit values are specified for this purpose by the central control device 12 as a function of the braking request. The central control device 12 is used as a central function to send torque specifications and rotational speed limit values to all available control units 13, 14, 15 and to the actuators 6, 8, 10, which are designed to exert a corresponding longitudinal torque as a brake torque on the respective wheel 3, 4.

The torque target values result in particular from the vehicle-wide braking request, for example as a function of an actuation of an actuation device, for example the brake pedal, by a driver of the motor vehicle 1 and/or by a specification of a vehicle assistance system, in particular in the context of emergency braking.

For the first and/or the second actuator 6, 8, preferably a common or a corresponding torque target value M_{S1} is specified as a function of a torque target value M_{S2} for the third actuator 10 and an actual torque M₃ generated by the third actuator 10. If, as described above, the drive device 9 acts on both wheels 3, 4, the same torque target value M_{S1} will be particularly preferably specified for the two actuators 6, 8.

If, for example, the corresponding control unit 13, 14 carries out a rotational speed control by means of an, in particular offset-based, rotational speed limit value, the corresponding torque target value M_{S1} will be preferably specified in such a way that a torque level of the third actuator 10 corresponds to a specification, i.e. the actual torque M₃ corresponds to the torque target value M_{S2}.

In particular, the torque target value M_{S1} for the first and/or the second actuator 6, 8 is iteratively specified and the target value of the wheel brake device is adjusted accordingly, wherein in particular a correction gain factor P is provided, and the level is maintained quickly or slowly depending on the correction gain factor P. For example, the torque target value M_{S1} for the k+1-th iteration is specified as follows as a function of the mentioned values and a torque M_{F}, for example specified by a driver, of the k-th iteration as a minimum of the torque M_{F} on the one hand and the sum of the torque target value M_{S1} and the product of the correction gain factor P and the difference between the torque target value M_{S2} and the actual torque M₃:

$${M}_{S 1} ( k + 1 ) = min ( {M}_{S 1} ( k ) + P * ( {M}_{S 2} ( k ) - {M}_{3} ( k ) ) , {M}_{F} ( k ) )$$

The method according to the present invention operates in the range of maximum deceleration, i.e., in particular in the range of an anti-lock braking system (ABS) or an anti-lock control. The rotational speed limit values and/or torque target values are preferably specified for each wheel 3, 4 and/or the axle 2 as a function of an optimal slip value.

In a step S3, for fulfilling the braking request, the actuators 6, 8, 10 are now controlled as a function of the specified torque target values and of the specified rotational speed limit values. According to the present invention, the actuators 6, 8, 10 are incorporated into the corresponding brake control exclusively via the mentioned torque and rotational speed interfaces.

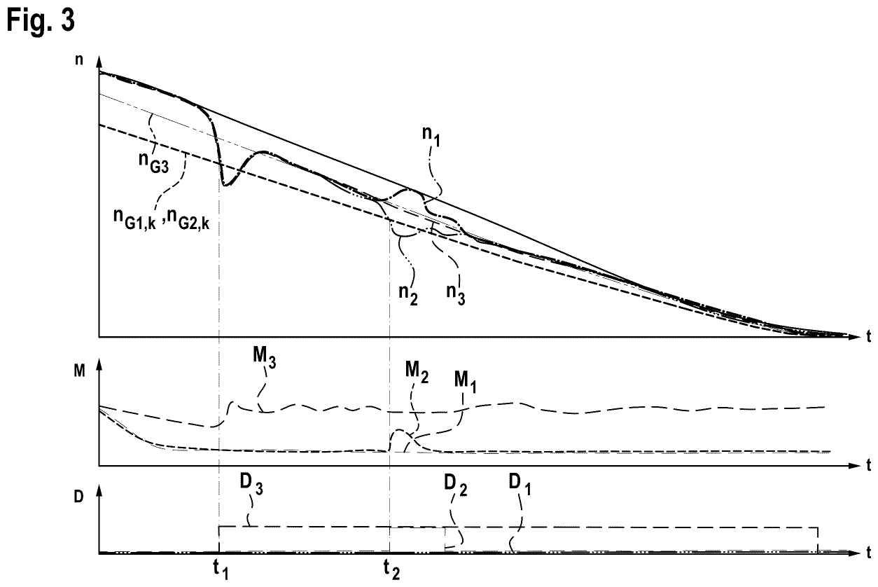

Each of the actuators 6, 8, 10 is controlled by the control unit 13, 14, 15 assigned to it, within the framework of rotational speed monitoring and rotational speed control. A temporal progression over time t of the corresponding values is shown in multiple diagrams arranged one above the other in FIG. 3.

A first rotational speed limit value n_{G1} for a rotational wheel speed of the first wheel 3 is specified for the first actuator 6, and a second rotational speed limit value n_{G2} of a rotational wheel speed of the second wheel 4 is specified for the second actuator 8. For the two rotational speed limit values n_{G1}, n_{G2}, a correction value Δn_{G1}, Δn_{G2} is ascertained, in particular as an offset, in each case as a function of a specified slip value at the corresponding wheel 3, 4, in particular as a function of a deviation from the specified slip value, and the rotational speed limit values n_{G1}, n_{G2} are specified for the corresponding actuators 6, 8 as corrected rotational speed limit values n_{G1,k}=n_{G1}−Δn_{G1}, n_{G2,k}=Δn_{G2}−n_{G2} reduced by the corresponding correction values Δn_{G1}, Δn_{G2}.

These corrected rotational speed limit values n_{G1,k}, n_{G2,k} are shown in FIG. 3 in an upper diagram of three, with overall rotational speed progressions being shown in the diagrams. In this case, the two corrected rotational speed limit values n_{G1,k}, n_{G2,k}, in particular also the rotational speed limit values n_{G1}, n_{G2} and thus the correction values Δn_{G1}, Δn_{G2} are identical because, in the present driving situation, the road surface friction coefficients at the wheels 3, 4 are not different (μsplit). Otherwise, the rotational speed limit values n_{G1}, n_{G2} could also be different, for example in a corresponding μ split situation.

For the third actuator 10, a third rotational speed limit value n_{G3} of a rotational axle speed of the axle 2 is analogously specified as a function of the first and the second (uncorrected) rotational speed limit values n_{G1}, n_{G2}, in this case as the average value of the two rotational speed limit values n_{G1}, n_{G2}.

The rotational speed limit values n_{G1}, n_{G2}, n_{G3} each have a decreasing progression over time with the corresponding actual rotational speeds of the wheels 3, 4 or of the axle 2. FIG. 3 shows corresponding actual rotational speeds, which are detected and monitored during the execution of the method, namely a first actual value n₁ of a rotational wheel speed of the first wheel 3, a second actual value n₂ of a rotational wheel speed of the second wheel 4, and a third actual value n₃ of a rotational axle speed of the axle 2.

Accordingly, the first limit value Δn_{G1,k} is assigned to the first actual value n₁, the second limit value n_{G2,k} is assigned to the second actual value n₂, and the third limit value n_{G3} is assigned to the third actual value n₃. Of course, limit values and actual values can also be expressed as corresponding angular velocities by multiplying them by 2π.

A middle diagram of the three in FIG. 3 shows torque progressions of torques M, namely a first actual torque M₁ generated by the first actuator 6, a second actual torque M₂ generated by the second actuator 8, and a third actual torque M₃ generated by the third actuator 10. The progressions initially follow the aforementioned target torques (not shown separately here), which are specified as a function of the braking request.

It can be seen that the control works such that the torques are selected in such a way that the corresponding actual values n₁, n₂, n₃ of the rotational speeds are as high as possible above their respective rotational speed limit values n_{G1,k}, n_{G2,k}, n_{G3}. Each actual value n₁, n₂, n₃ is continuously compared to its corresponding rotational speed limit value n_{G1,k}, n_{G2,k}, n_{G3}. If it is detected that the particular actual value n₁, n₂, n₃ falls below the rotational speed limit value n_{G1,k}, n_{G2,k}, n_{G3}, the corresponding actuator 6, 8, 10, in particular the first or the second actuator 6, 8, will be controlled to reduce the torque, until the actual value n₁, n₂, n₃ at least reaches the rotational speed limit value n_{G1,k}, n_{G2,k}, n_{G3} again. The particular actuator 6, 8, 10 is permitted to deviate from the corresponding target torque.

For this purpose, a corresponding rotational speed control is activated, the activation of which is shown in binary form in the third of the three diagrams for each of the actuators 6, 8, 10. Each of the actuators 6, 8, 10 is assigned a corresponding progression, namely, the first actuator is assigned the rotational speed control D₁, the second actuator 8 is assigned the rotational speed control D₂, and the third actuator is assigned the rotational speed control D₃.

At a time t₁, the rotational speed control D₃ of the actuator 10 assigned to the drive device is activated first. This is triggered by the fact that, at the time t₁, the actual value n₃ falls below its rotational speed limit value n_{G3}. For a short time, the other two actual values also fall below their limit values, but this is quickly compensated by the starting rotational speed control D₃ and the torque M₃.

Only at a time t₂, at which only the second actual value n₂ falls below its limit value n_{G2,k}, is the rotational speed control D₂ of the second actuator 8 activated, and the (negative) torque M₂ reduced for a short time until the actual value n₂ again exceeds its limit value n_{G2,k}.

The method ends in a step S4 when the braking request is 10 fulfilled, for example when the motor vehicle 1 has come to a standstill, as also indicated in FIG. 3, where the corresponding rotational speeds all become zero in the temporal progression.

1-11. (canceled)

12. A method for operating a motor vehicle, the motor vehicle having at least one axle with a first wheel and a second wheel, wherein the first wheel, assigned to a left-hand side of the motor vehicle, is assigned a first wheel brake device with a controllable first actuator including an electric machine, wherein the second wheel, assigned to a right-hand side of the motor vehicle, is assigned a second wheel brake device with a controllable second actuator including an electric machine, and wherein the first and second wheels are assigned a common drive device, or each of the first and second wheels is assigned a separate drive device, each common or separate drive device including a controllable third actuator including an electric machine, the method comprising the following steps:
specifying at least one torque target value and one rotational speed limit value as a function of a braking request for a maximum deceleration of the motor vehicle; and
for fulfilling the braking request, controlling the first, second, and third actuators as a function of the specified torque target value and the specified rotational speed limit value.

13. The method according to claim 12, wherein a corresponding rotational speed limit value and/or torque target value is specified for each of the first and second wheels and/or the axle, as a function of an optimum slip value.

14. The method according to claim 12, wherein, for the first and/or the second actuator, a common or a corresponding torque target value is specified as a function of a torque target value for the third actuator and an actual torque generated by the third actuator.

15. The method according to claim 12, wherein: (i) the torque target value and the rotational speed limit value are specified by a central control device, and/or (ii) each of the first, second, and third actuators is assigned its own control unit, which is connected to the central control device by communication technology, wherein each of the first, second, and third actuators is controlled by the control unit assigned to it.

16. The method according to claim 12, wherein a first rotational speed limit value of a rotational wheel speed of the first wheel for the first actuator and a second rotational speed limit value of a rotational wheel speed of the second wheel for the second actuator, are ascertained and/or specified.

17. The method according to claim 16, wherein a third rotational speed limit value of a rotational axle speed of the axle for the third actuator is specified as a function of the first and second rotational speed limit values, as an average value of the first and the second rotational speed limit values.

18. The method according to claim 16, wherein, for the first and the second ascertained rotational speed limit values, a corresponding correction value is ascertained, as an offset, in each case as a function of a specified slip value at a corresponding wheel of the first and second wheels, including as a function of a deviation from the specified slip value, and the rotational speed limit values are specified for corresponding actuators of the first, second, and third actuators, as rotational speed limit values reduced by the corresponding correction values.

19. The method according to claim 16, wherein an actual value of a rotational wheel speed of the first wheel, and/or an actual value of a rotational wheel speed of the second wheel, and/or an actual value of a rotational axle speed of the axle are detected, wherein each actual value is compared with a corresponding rotational speed limit value, and when it is detected that the actual value falls below the corresponding rotational speed limit value, a corresponding actuator of the first or the second actuator, is controlled to reduce torque, until the actual value at least reaches the rotational speed limit value again.

20. A non-transitory machine-readable storeable medium on which is stored a computer program for operating a motor vehicle, the motor vehicle having at least one axle with a first wheel and a second wheel, wherein the first wheel, assigned to a left-hand side of the motor vehicle, is assigned a first wheel brake device with a controllable first actuator including an electric machine, wherein the second wheel, assigned to a right-hand side of the motor vehicle, is assigned a second wheel brake device with a controllable second actuator including an electric machine, and wherein the first and second wheels are assigned a common drive device, or each of the first and second wheels is assigned a separate drive device, each common or separate device including a controllable third actuator including an electric machine, the computer program, when executed by a computer, causing the computer to perform the following steps:
specifying at least one torque target value and one rotational speed limit value as a function of a braking request for a maximum deceleration of the motor vehicle; and
for fulfilling the braking request, controlling the first, second, and third actuators as a function of the specified torque target value and the specified rotational speed limit value.

21. An electronic control device for a motor vehicle, the electronic control device being specifically configured to operate the motor vehicle, the motor vehicle having at least one axle with a first wheel and a second wheel, wherein the first wheel, assigned to a left-hand side of the motor vehicle, is assigned a first wheel brake device with a controllable first actuator including an electric machine, wherein the second wheel, assigned to a right-hand side of the motor vehicle, is assigned a second wheel brake device with a controllable second actuator including an electric machine, and wherein the first and second wheels are assigned a common drive device, or each of the first and second wheels is assigned a separate drive device, each common or separate device including a controllable third actuator including an electric machine, the electronic control device being specifically configured to perform the following steps:
specifying at least one torque target value and one rotational speed limit value as a function of a braking request for a maximum deceleration of the motor vehicle; and
for fulfilling the braking request, controlling the first, second, and third actuators as a function of the specified torque target value and the specified rotational speed limit value.
